(19) United States
(12) Patent Application Publication
(10) Pub. No.: US 2010/0075278 A1
(43) Pub. Date: Mar. 25, 2010

(54) Dental Prosthetics Having Improved Aesthetic Appearance and Method of Preparing Same

(76) Inventor: Ron Fishell, Garland, TX (US)

Correspondence Address: THE DANAMRAJ LAW GROUP, P.C., PREMIER PLACE, SUITE 1450, 5910 N. CENTRAL EXPRESSWAY, DALLAS, TX, 75206, US

(21) Appl. No.: 12/234,273

(22) Filed: Sep. 19, 2008

(51) Int. Cl. A61C 13/00

(52) U.S. Cl. 433/201.1

(57) ABSTRACT

A dental prosthetic substructure comprising an alloy. In one embodiment, the alloy comprises a first mixture comprising about 50 percent to about 99.95 percent by weight of the alloy and a second mixture comprising at least 0.05 percent to about 5 percent by weight of the alloy. The first mixture comprises at least two precious metals. The second mixture comprises at least one precious metal.

The present disclosure is directed to dental prosthetics, and in particular to a group of novel alloys, to dental prosthetics made from such alloys and to methods for preparing the dental prosthetics.

### BACKGROUND

Metallic substructures for dental prosthetics are fabricated using a variety of manufacturing processes, including lost wax casting, powder metallurgy and electroforming. The metallic substructures are generally formed from a precious metal or an alloy of precious metals. Because patients desire teeth having a natural appearance, a white veneer is normally overlaid on top of the metallic substructure. Owing to the nature of precious metals, adhesion of the veneer to the substructure has been identified as a problem.

### BRIEF DESCRIPTION OF THE DRAWINGS

For a more complete understanding of the features and advantages of the present method and apparatus, reference is now made to the detailed description along with the accompanying figures in which corresponding numerals in the different figures refer to corresponding parts and in which:

FIG. 1 is a section view of a damaged tooth in need of treatment;

FIG. 2 is a section view of the damaged tooth after it has been prepared to receive a crown;

FIG. 3 is a section view of the prepared tooth with a metallic substructure in place;

FIG. 4 is a section view of the tooth with a cosmetic veneer disposed around the metallic substructure;

FIG. 5 depicts a flowchart of the steps shown in FIGS. 1-4;

FIG. 6 is a table showing certain alloys within the scope of the present disclosure;

FIG. 7 depicts a set of bar graphs showing the composition of certain alloys within the scope of the present disclosure;

FIG. 8 depicts a graph showing a range of proportions of metals within certain alloys within the scope of the present disclosure;

FIG. 9 depicts a graph showing a range of proportions of certain metals within certain alloys within the scope of the present disclosure;

FIG. 10 depicts a graph showing a range of proportions of gold to palladium within certain alloys within the scope of the present disclosure;

FIG. 11 depicts a graph showing a range of proportions of silver to platinum within certain alloys within the scope of the present disclosure;

FIG. 12 depicts a graph showing a range of proportions of iridium to ruthenium within certain alloys within the scope of the present disclosure;

FIG. 13 depicts a graph showing a range of proportions of gold, palladium, silver, ruthenium and iridium within certain alloys within the scope of the present disclosure;

FIG. 14 depicts a flowchart showing a method of manufacturing a metallic substructure; and

FIGS. 15-18 depict certain steps of the process set forth in FIG. 14.

### DETAILED DESCRIPTION OF THE DRAWINGS

While the composition of various embodiments is discussed in detail below, it should be appreciated that the present application provides many applicable inventive concepts which can be embodied in a wide variety of specific contexts. The specific embodiments discussed herein are merely illustrative of specific ways to use the disclosed teachings, and do not delimit the scope of the present application.

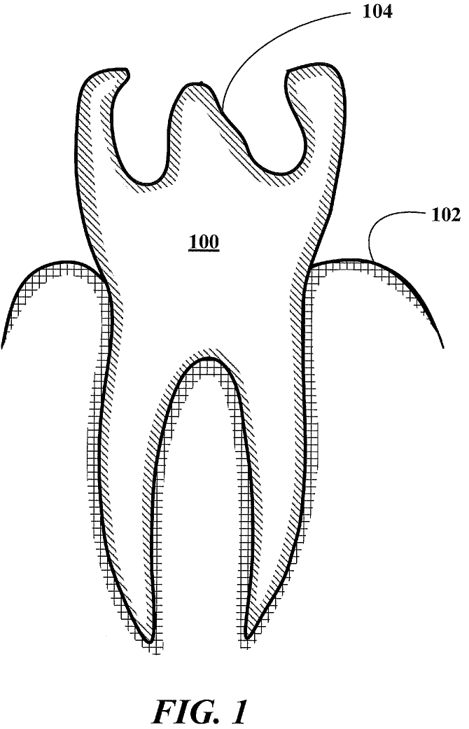

FIG. 1 depicts a tooth 100 disposed in a patient's jaw 102. Tooth 100 has internal cavities, or decayed portions 104, necessitating treatment. In certain cases, damage to a tooth can be treated with fillings. In other cases, damage can be sufficiently extensive that the structural integrity of the tooth is compromised. In such cases, a filling is not an appropriate treatment, and a dental prosthetic is necessary. Tooth 100 represents a tooth having a sufficient level of decay that a filling is not appropriate. A dental prosthetic crown is an appropriate treatment.

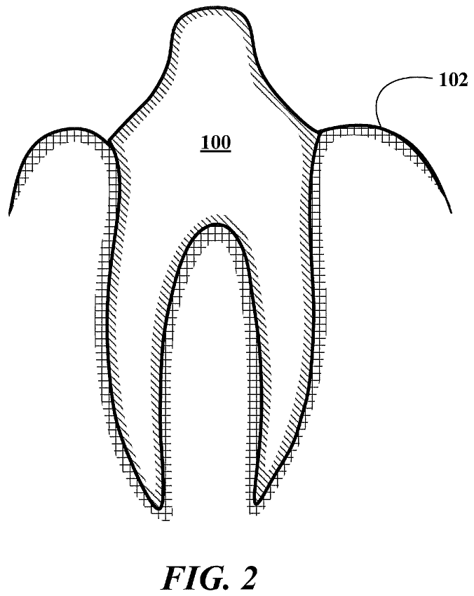

In order to prepare tooth 100 to receive a crown, the top end of tooth 100 is mechanically removed using cutting tools, and the remaining tooth structure is shaped to receive a crown. FIG. 2 depicts tooth 100 after it has been prepared to receive the crown.

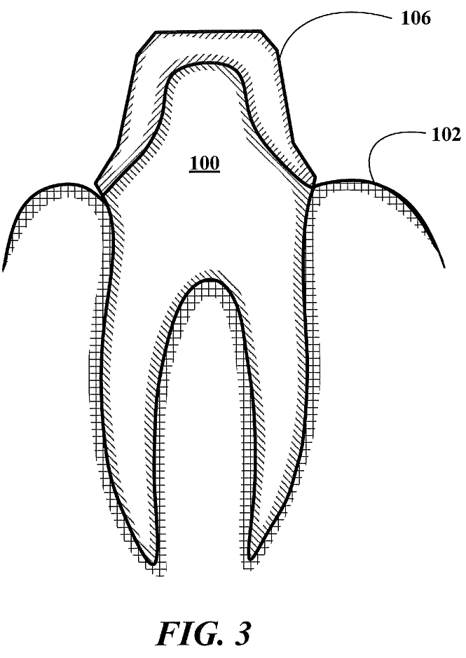

Once the tooth is appropriately shaped to receive a crown, a metallic substructure is manufactured to fit the prepared upper surface of the tooth. The metallic substructure comprises a precious metal or metal alloy, as described in further detail below. The substructure is custom manufactured in a laboratory with an internal surface shaped to conform to the external upper surface of the tooth. The metallic substructure can be manufactured according to a wide variety of manufacturing methods, as also discussed in further detail below. FIG. 3 depicts tooth 100 with a custom-made metallic substructure 106 set in place.

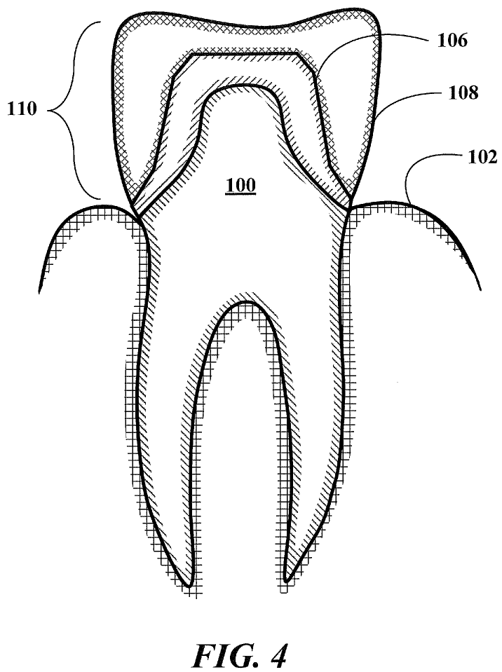

Once the metallic substructure 106 is manufactured, a cosmetic veneer is disposed over the surface of the metallic substructure 106 in order to provide a natural appearance. FIG. 4 depicts a completed dental prosthetic 108 including the cosmetic veneer. Dental prosthetic 108 comprises the combination of the original tooth 100 in combination with the assembled crown 112. The crown 112 comprises metal substructure 106 overlaid with a cosmetic veneer 110. The veneer 110 may comprise any one of a wide variety of materials, including porcelain, polymers and composites. Although a single molar-style crown is presented in FIGS. 1-4 by way of example, those of skill in the art will appreciate that the teachings of the present disclosure may be applied toward the manufacture of a wide variety of dental prosthetics, including but not limited to crowns and bridges.

As noted above, the metallic substructure 106 can be made of a variety of alloys and can be made by means of a variety of manufacturing methods. According to one embodiment, the metallic substructure is cast from a precious metal alloy using the well-known lost wax process.

The alloy from which metallic substructure 106 comprises Group IB and Group VIIIB precious metals in varying amounts. In general, the alloy comprises a mixture of two or more of gold, palladium, silver and platinum comprising at least about 95 percent, and no more than about 99.95 percent, of the alloy by weight. The alloy further comprises a mixture of ruthenium, iridium and rhodium comprising at least about 0.05 percent, and no more than about 5 percent, of the alloy by weight. Specific alloys may comprise silver in the amount of about 1 percent to about 50 percent by weight, platinum in the amount of about 3 percent to about 20 percent by weight, or rhodium in the amount of about 3 percent by weight. In certain embodiments, the portion of gold and the portion of palladium will together comprise at least 50 percent of the alloy by weight.

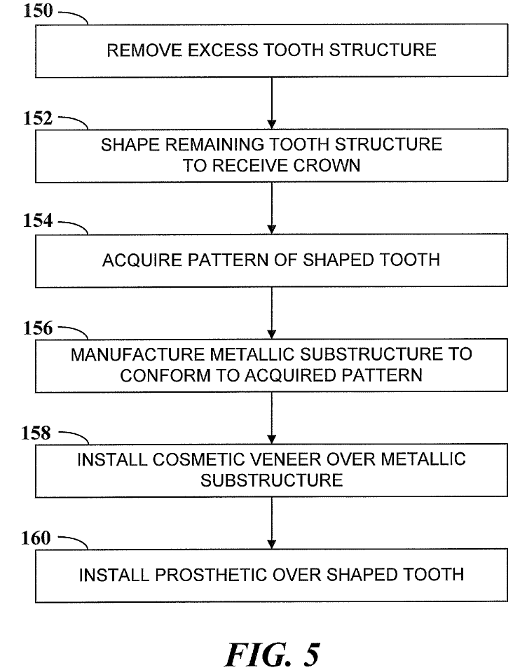

FIG. 5 depicts a flowchart of the steps shown in FIGS. 1-4. Process flow begins in block 150, wherein excess tooth structure is removed, and then moves to block 152, wherein the remaining tooth structure is shaped to receive a crown. Before these steps, tooth 100 has the appearance shown in FIG. 1. After these steps, tooth 100 has the appearance shown in FIG. 2.

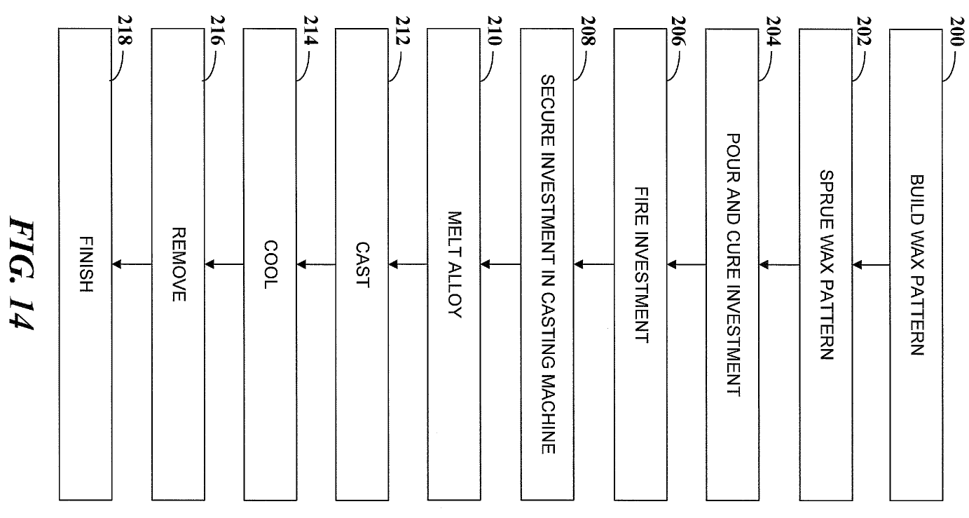

In block 154, a dentist acquires the pattern of the shaped tooth in order to manufacture a matching crown. In block 156, a laboratory manufactures a metallic substructure to conform to the acquired pattern. The substructure may be manufactured by means of a number of methods. One process for manufacturing the metallic substructure is set forth in FIGS. 14-18. Prior to installation of the metallic substructure, the dental technician may apply a bonding agent to the metallic substructure. A variety of commercially-available bonding agents may be used, including BONDER from OutSource Dental of Garland, Tex. and similar products available from Aurident, Inc. of Fullerton, Calif. Those of skill in the art will appreciate that alternate bonding agents may be employed. In one embodiment, the bonding agent may be mixed into a slurry and applied as a thin wash in such a manner as to create a hazy finish. After application, the bonding agent may be fired using a temperature profile starting at approximately 500 degrees Celsius, climbing at approximately 60 degrees Celsius per minute up to a temperature of approximately 1000 degrees Celsius. Those of skill in the art will appreciate that alternate temperature profiles may be employed. The metallic substructure may be test-fitted to the shaped tooth, as shown in FIG. 3.

In block 158, the dental technician installs a cosmetic veneer over the metallic substructure. Prior to installation of the cosmetic veneer, a colorant may be applied to the inside surface of the veneer. Prior to firing of the colorant, the inside surface of the veneer may be blasted with an abrasive, such as aluminum oxide. The colorant may be fired after the veneer is fired, at a temperature 10 degrees Celsius below the glaze temperature. After firing, the colorant may be glass beaded at a pressure of 25-40 psi. In block 160, the dentist installs the prosthetic over the shaped tooth. After installation of the prosthetic, tooth 100 has the appearance shown in FIG. 4.

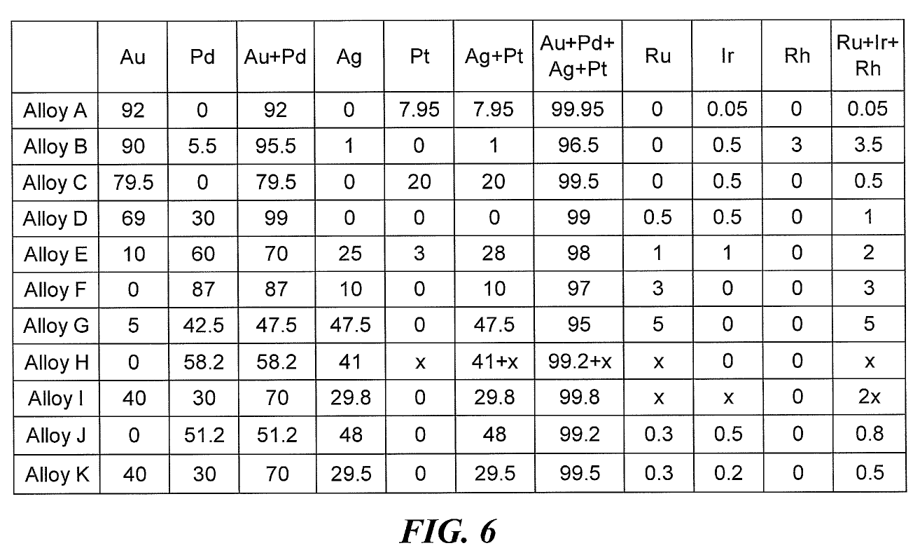

FIG. 6 is a table showing certain alloys A-K within the scope of the present disclosure. These nine alloys are alloys of gold (Au), palladium (Pd), silver (Ag), platinum (Pt), ruthenium (Ru), iridium (Ir) and rhodium (Rh). Some of these alloys are alloys constituting less than all of these elements. Alloy A, for example, comprises only gold, platinum and iridium. Conversely, Alloy F comprises only palladium, silver and ruthenium. Although FIG. 6 depicts nine specific alloys according to the present disclosure, a variety of other alloys will be apparent to those of skill in the art.

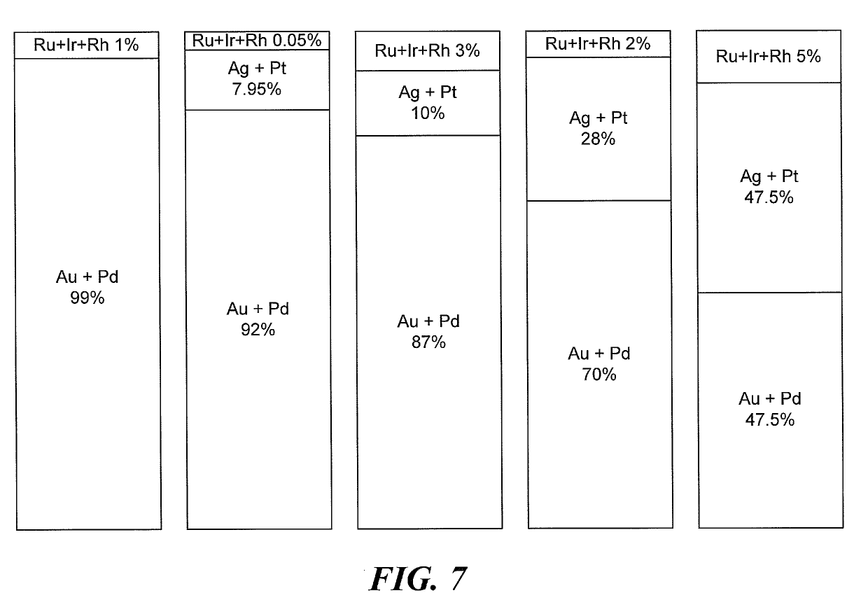

FIG. 7 depicts certain alloys of FIG. 6 in a graphical form. On the left end of FIG. 7 is a graphical representation of Alloy D, which comprises 99% gold and palladium in combination with 1% iridium and ruthenium. On the right end of FIG. 7 is a graphical representation of Alloy G, which comprises 47.5% gold and palladium in combination with 47.5% silver and platinum and 5% ruthenium. Between these two representations are graphical representations of other alloys listed in FIG. 6, including Alloy A, Alloy F and Alloy E.

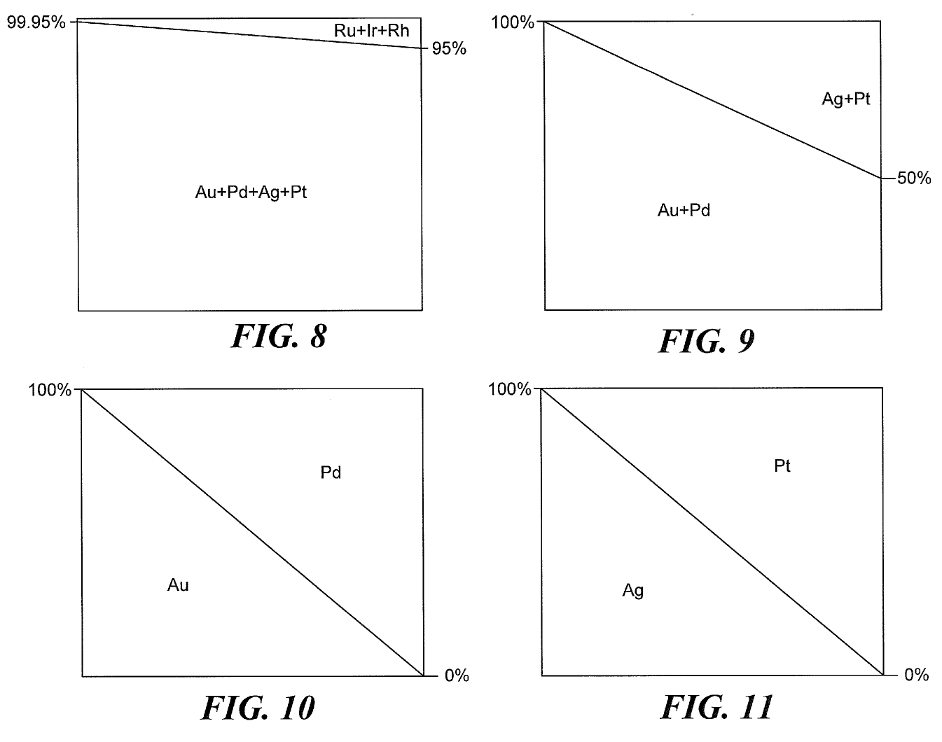

FIG. 8 depicts a graph showing a range of proportions of metals within certain alloys within the scope of the present disclosure. FIG. 8 shows, on the left end, a mixture of 99.95% gold, palladium, silver and platinum in combination with a mixture of 0.05% ruthenium, iridium and rhodium. On the right end, FIG. 8 shows a mixture of 95% gold, palladium, silver and platinum in combination with a mixture of 5% ruthenium, iridium and rhodium.

FIG. 9 depicts a graph showing a range of proportions of certain metals within certain alloys within the scope of the present disclosure. In certain alloys, the alloy may comprise only trace amounts of silver and platinum. In other alloys, the combination of silver and platinum together may range as high as 50% of the overall mass of gold, palladium, silver and platinum within the alloy.

FIG. 10 depicts a graph showing a range of proportions of gold to palladium within certain alloys within the scope of the present disclosure. From this graph, it can be seen that certain alloys may comprise no palladium, while other alloys may comprise no gold. In between the two extremes, the ratio of palladium to gold may vary considerably.

FIG. 11 depicts a graph showing a range of proportions of silver to platinum within certain alloys within the scope of the present disclosure. From this graph, it can be seen that certain alloys may comprise no silver, while other alloys may comprise no platinum. Between the two extremes, the ratio of silver to platinum may vary considerably.

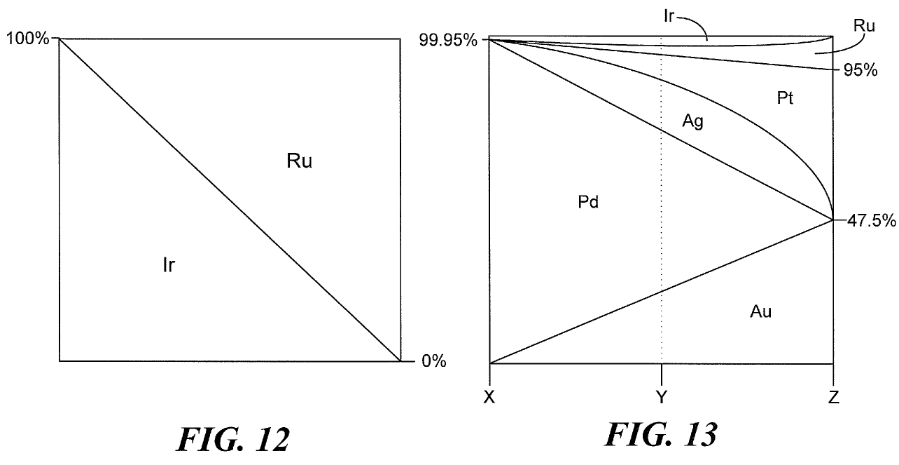

FIG. 12 depicts a graph showing a range of proportions of iridium to ruthenium within certain alloys within the scope of the present disclosure. From this graph, it can be seen that certain alloys may comprise no ruthenium, while other alloys may comprise no iridium. Between the two extremes, the ratio of iridium to ruthenium may vary considerably.

FIG. 13 depicts a graph showing a range of proportions of gold, palladium, silver, ruthenium and iridium within certain alloys within the scope of the present disclosure. From this graph, it can be seen that palladium may comprise up to 99.95% of the alloy down to 0%. Gold may comprise between 0% up to 47.5% Platinum varies within the same range. Ruthenium comprises between 0% and 5% of the alloy, while silver may vary from 0% to 15%. Those of skill in the art will recognize that FIG. 13 disloses only certain embodiments of the present disclosure.

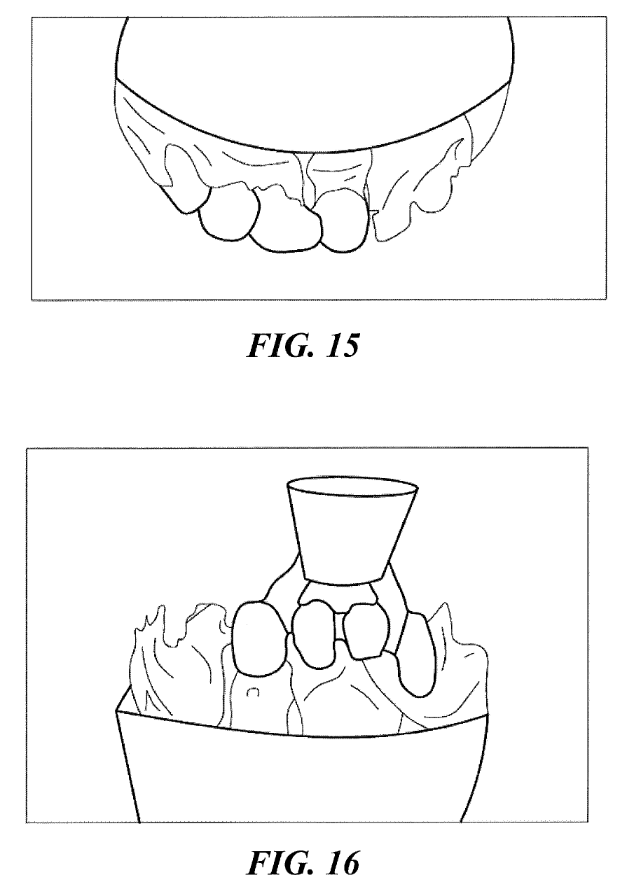

FIG. 14 depicts a flowchart depicting a process for manufacture of a metallic substructure according to the present disclosure. FIGS. 15-18 depict various stages of the manufacturing process. The process begins with building (200) a wax pattern having a shape of the substructure to be formed, as shown in FIG. 15. The wax pattern is then sprued (202), as shown in FIG. 16. In certain embodiments, short 8 gage direct sprues are used. In certain embodiments, bridges are sprued at the connections and each abutment. A plaster investment is poured (204) around the sprued wax form. In certain embodiments, the pattern is kept within 0.25″ of the top of the investment.

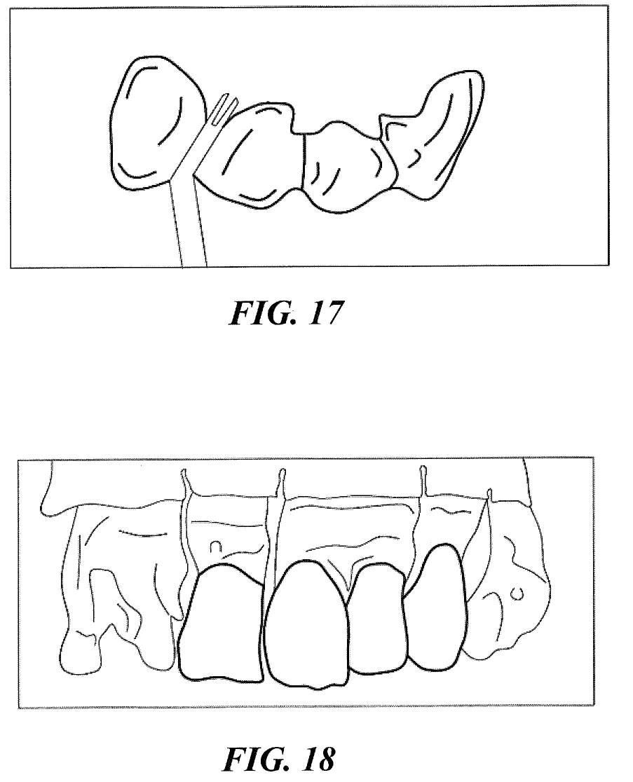

After the investment is cured, it is fired (206) to remove the wax form. In certain embodiments, rapid or regular burnout may be used, at a burnout temperature of 1700 degrees fahrenheit. The investment is secured (208) into a casting machine. The selected alloy is then melted (210), using, for example, an oxygen/gas torch. Use of a new crucible is recommended. The casting machine is released to spin the alloy melt into the ring mold, thereby casting the substructure (212), which is then cooled (214) and removed from the investment (216). After trimming of the sprues, the substructure has the general appearance shown in FIG. 17. Final fitment and finishing (216) is then performed on the substructure, as shown in FIG. 18. Final finshing may include glass beading, grinding and smoothing, and final light surface treatment with a carbide or diamond tool.

While this application has described alloys and prosthetics with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is, therefore, intended that the appended claims encompass any such modifications or embodiments.

What is claimed is:

1. A dental prosthetic substructure comprising an alloy, the alloy comprising:
a first mixture comprising gold and at least one of platinum, palladium or silver, the first mixture comprising about 50 percent to about 99.95 percent by weight of the alloy; and
a second mixture comprising at least one of rhodium, iridium or ruthenium, the second mixture comprising at least 0.05 percent to about 5 percent by weight of the alloy.

2. The dental prosthetic of claim 1 wherein gold comprises at least 69 percent of the substructure.

3. The dental prosthetic of claim 1 wherein palladium comprises at least 45 percent of the substructure.

4. The dental prosthetic of claim 1 wherein iridium comprises at least 0.5 percent of the substructure.

5. The dental prosthetic of claim 1 wherein platinum comprises at least 7.95 percent of the substructure.

6. The dental prosthetic of claim 1 wherein platinum comprises at least 20 percent of the substructure.

7. The dental prosthetic of claim 1 wherein the substructure comprises at least 1 percent silver.

8. A dental prosthetic substructure comprising:
at least 60 percent of a first metal selected from one of gold and palladium;
at least 10 percent of a second metal selected from the other of gold and palladium;
at least 0.5 percent ruthenium; and
at least 0.5 percent iridium.

9. The dental prosthetic substructure of claim 8 wherein the first metal is gold and wherein gold comprises at least 69 percent of the substructure.

10. The dental prosthetic substructure of claim 8 wherein the first metal is palladium and wherein gold comprises at least 30 percent of the substructure.

11. The dental prosthetic substructure of claim 8 wherein the substructure comprises at least 25 percent silver.

12. The dental prosthetic substructure of claim 8 wherein the substructure comprises at least 3 percent platinum.

13. The dental prosthetic substructure of claim 8 wherein the substructure comprises at least 1 percent ruthenium.

14. The dental prosthetic substructure of claim 8 wherein the substructure comprises at least 1 percent iridium.

15. A dental prosthetic substructure comprising:
at least 30 percent palladium;
at least 10 percent silver; and
at least 1 percent ruthenium.

16. The dental prosthetic substructure of claim 15, further comprising at least 5 percent gold.

17. The dental prosthetic substructure of claim 15, further comprising at least 3 percent platinum.

18. The dental prosthetic substructure of claim 15, further comprising at least 0.05 percent iridium.

19. The dental prosthetic substructure of claim 15, further comprising at least 3 percent rhodium.

20. The dental prosthetic substructure of claim 15, wherein the substructure comprises at least 50 percent silver.

21. A dental prosthetic substructure comprising:
approximately 51% by weight of palladium;
approximately 48% by weight of silver;
approximately 0.3% by weight of ruthenium; and
approximately 0.5% by weight of iridium.

22. A dental prosthetic substructure comprising:
approximately 40% by weight of gold;
approximately 30% by weight of palladium;
approximately 29.5% of silver;
approximately 0.3% by weight of ruthenium; and
approximately 0.2% by weight of iridium.
